(19) United States
(12) Patent Application Publication
(10) Pub. No.: US 2026/0149339 A1
(43) Pub. Date: May 28, 2026

(54) ELECTRICAL MACHINE FOR A MOTOR VEHICLE, COMPRISING A PIEZOELECTRIC ROLLER

(71) Applicant: AUMOVIO Germany GmbH, Frankfurt am Main (DE)

(72) Inventors: Bertrand VAROQUIE, Eaunes (FR); Eric SENECHAL, Cugnaux (FR)

(73) Assignee: AUMOVIO Germany GmbH, Frankfurt am Main (DE)

(21) Appl. No.: 19/386,411

(22) Filed: Nov. 12, 2025

(30) Foreign Application Priority Data
Nov. 22, 2024 (FR) 2412839

(51) Int. Cl. H02K 11/25

(52) U.S. Cl. CPC H02K 11/25

(57) ABSTRACT

An electrical machine for a motor vehicle, including a stator and a rotor mounted on the stator such that it is able to rotate by a rotation shaft and a plurality of rolling modules. At least one rolling element of at least one rolling module includes a “main” piezoelectric transceiver configured to transmit an ultrasonic supply signal, the electrical machine including a sensor mounted inside the rotor.

### CROSS REFERENCE TO RELATED APPLICATION

This application claims priority to French Application No. 2412839, filed Nov. 22, 2024, the contents of such application being incorporated by reference herein.

### FIELD OF THE INVENTION

The present invention relates to the field of motor vehicles and more particularly concerns an electrical machine for a motor vehicle, comprising a piezoelectric roller for measuring parameters such as, for example, the temperature inside the rotor.

### BACKGROUND OF THE INVENTION

In a known manner, an electric motor includes a rotor and a stator. The operation of such a motor causes heating of the rotor and the stator. However, the increase in temperature of the rotor may lead to performance losses and to demagnetization of the magnets placed inside beyond a certain temperature, this possibly leading to damage or even failure of the motor. It is therefore necessary to measure the temperature inside the rotor so as to be able to reduce the speed of the latter when the temperature approaches the critical operating limit and thus avoid damaging the motor or else failure thereof.

The temperature of the rotor is difficult to measure directly using wired temperature sensors because the rotor rotates during operation; the temperature is therefore estimated using algorithms and models integrated into the management system of the motor.

However, these integrated models and algorithms cause measurement errors which may reach plus or minus 20° C., this not being satisfactory for controlling the motor in order to avoid damaging it or causing failure thereof.

A simple, reliable and efficient solution allowing these drawbacks to be at least partly overcome would therefore be advantageous.

### SUMMARY OF THE INVENTION

To this end, an aspect of the invention first of all relates to an electrical machine for a motor vehicle, said electrical machine comprising a stator and a rotor mounted on said stator such that it is able to rotate by means of a rotation shaft and a plurality of rolling modules, each rolling module comprising a fixed element mounted on the stator, a movable element mounted on the rotor, at least one rolling element mounted between the fixed element and the movable element and configured to allow the rotor to rotate relative to the stator, the electrical machine being noteworthy in that:
at least one rolling element of at least one rolling module is a “main” piezoelectric transceiver configured to transmit an ultrasonic supply signal,
the stator comprises a control stage configured to command said main piezoelectric transceiver to transmit,
the electrical machine comprises a sensor, mounted inside the rotor, comprising a “remote” piezoelectric transceiver, a measurement stage and a sensitive element, said remote piezoelectric transceiver being configured to receive the ultrasonic supply signal and to transmit it to the measurement stage, the measurement stage being configured to collect and store the electrical energy contained in the received ultrasonic supply signal and to electrically power the sensitive element on the basis of the stored electrical energy, the sensitive element being configured to measure a parameter inside the rotor, to generate a measurement signal including at least one value of the measured parameter and to transmit said generated measurement signal to the measurement stage, the measurement stage being configured to extract the at least one value of the measured parameter contained in the measurement signal, to generate an ultrasonic response signal including the at least one extracted value of the parameter, and to command the remote piezoelectric transceiver to transmit said generated ultrasonic response signal, the main piezoelectric transceiver being configured to receive said ultrasonic response signal and to transmit said received ultrasonic response signal to the control stage, said control stage being configured to extract the at least one value of the parameter contained in the transmitted ultrasonic response signal.

The device according to an aspect of the invention makes it possible to carry out measurements at a distance via the remote module by powering the sensitive measuring element on the basis of the energy from signals sent by the main module over a non-wired link. Thus, the measurements may be carried out as close as possible to the magnets, this increasing the performance of the control of the electrical machine. An aspect of the invention also makes it possible to dispense with metal barriers such as, for example, the casing and the protective flanges, which block electromagnetic waves of Wi-Fi or Bluetooth type. Using one or more rolling elements to constitute the main piezoelectric transceiver allows the signals to be transmitted to the sensor efficiently, said signals no longer being attenuated by the rolling module.

Preferably, the main piezoelectric transceiver is made of ceramic.

In one embodiment, the main piezoelectric transceiver is a ball or a roller.

In another embodiment, the main piezoelectric transceiver is a crown, a ring or a torus.

In one embodiment, all the rolling elements of at least one rolling module are main piezoelectric transceivers.

In one embodiment, each rolling module is circular and entirely surrounds the rotation shaft of the rotor.

Advantageously, the control stage is configured to control the position of the rotor in dependence on the at least one extracted value of the parameter.

In one embodiment, the sensor further comprising an external communication stage, the measurement stage may be configured to command the transmission of signals containing the measured values via said external communication stage. The measured values may thus be sent to an entity outside the measurement device for processing. The external communication stage may, for example, transmit using a communication protocol of Bluetooth, Wi-Fi, 5G or RFID type.

In one embodiment, the main piezoelectric transceiver being configured to resonate at at least one predetermined frequency, the control stage is configured to generate a signal at said at least one predetermined frequency and to deliver the generated signal to the main piezoelectric transceiver, and the remote piezoelectric transceiver is configured to resonate at said at least one predetermined frequency. These technical features allow selectivity in communication and in particular allow a plurality of sensors to be used with a single main piezoelectric transceiver, this improving performance and making it possible to adjust the frequency in dependence on the specific modes of the electrical machine and the acoustic reflections. An aspect of the invention also concerns a motor vehicle comprising an electrical machine as described above, said electrical machine being configured to drive the wheels of said vehicle in rotation. An aspect of the invention also concerns a method for measuring a parameter in a rotor of an electrical machine of a motor vehicle, said method comprising the steps of:
commanding, by the control stage, the main piezoelectric transceiver to transmit,
transmission, by the main piezoelectric transceiver, of an ultrasonic supply signal,
reception, by the remote piezoelectric transceiver, of the transmitted ultrasonic supply signal,
collection and storage, by the measurement stage, of the electrical energy contained in the received ultrasonic supply signal,
electrical powering, by the measurement stage, of the sensitive element on the basis of the stored electrical energy,
measurement, by the sensitive element, of the parameter,
generation, by the sensitive element, of a measurement signal including at least one value of the measured parameter,
transmission, by the sensitive element, of the generated measurement signal to the measurement stage,
extraction, by the measurement stage, of the at least one value of the measured parameter contained in the transmitted measurement signal,
generation, by the measurement stage, of an ultrasonic response signal including the at least one extracted value of the parameter,
commanding, by the measurement stage, the remote piezoelectric transceiver to transmit said generated ultrasonic response signal,
transmission, by the remote piezoelectric transceiver, of said generated ultrasonic response signal,
reception, by the main piezoelectric transceiver, of the transmitted ultrasonic response signal,
transmission, by the main piezoelectric transceiver, of the received ultrasonic response signal to the control stage,
extraction, by the control stage, of the at least one value of the parameter contained in the transmitted ultrasonic response signal.

Advantageously, the method comprises a step in which the control stage controls the position of the rotor on the basis of the at least one extracted value of the parameter.

### BRIEF DESCRIPTION OF THE DRAWINGS

Other features and advantages of aspects of the invention will become more apparent upon reading the following description. It is purely illustrative and should be read with reference to the appended drawings, in which:

FIG. 1 is a schematic cross-sectional view of an example of an electrical machine according to an aspect of the invention.

FIG. 2 schematically illustrates, in a block diagram, a first embodiment of the electrical machine according to the invention.

FIG. 3 schematically illustrates, in a block diagram, a second embodiment of the electrical machine according to the invention.

FIG. 4 is a schematic cross-sectional view of a first example of a rolling module of an electrical machine according to an aspect of the invention.

FIG. 5 is a schematic cross-sectional view of a second example of a rolling module of an electrical machine according to an aspect of the invention.

FIG. 6 schematically illustrates an embodiment of the method according to the invention.

### DETAILED DESCRIPTION OF EXEMPLARY EMBODIMENTS

FIG. 1 is an example of an electrical machine 1 according to an aspect of the invention. The electrical machine 1 is intended to be mounted in a motor vehicle in order to drive the wheels thereof in rotation.

The electrical machine 1 comprises a stator 10 and a rotor 20 mounted on said stator 10 such that it is able to rotate.

The stator 10 comprises a control stage 110 and a main piezoelectric transceiver 120.

The control stage 110 is configured to command said main piezoelectric transceiver 120 to transmit.

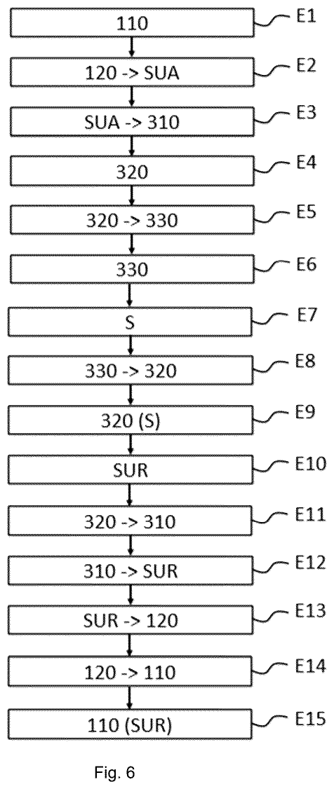

The main piezoelectric transceiver 120 is configured to transmit an ultrasonic “supply” signal SUA (FIG. 6) and to receive an ultrasonic “response” signal SUR (FIG. 6).

The electrical machine 1 also comprises a sensor 30 mounted inside the rotor 20.

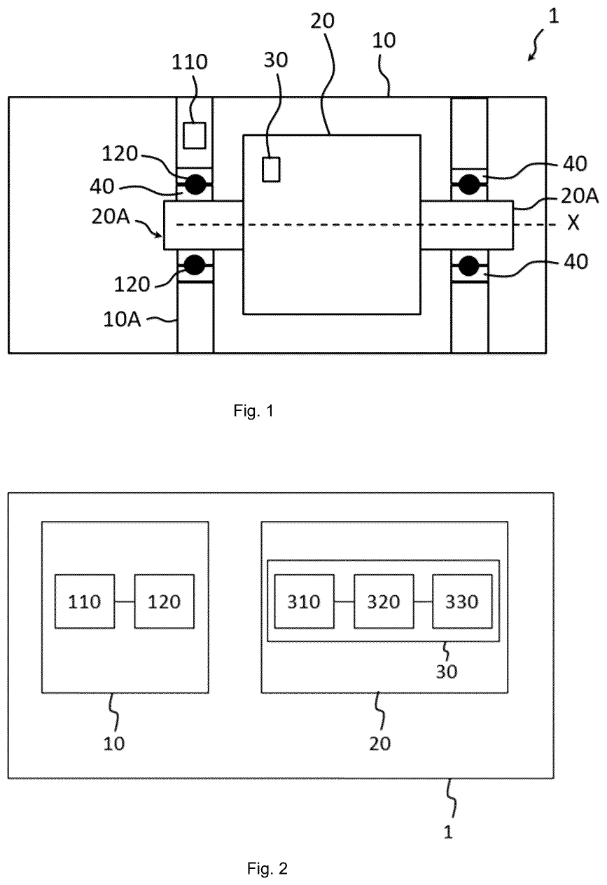

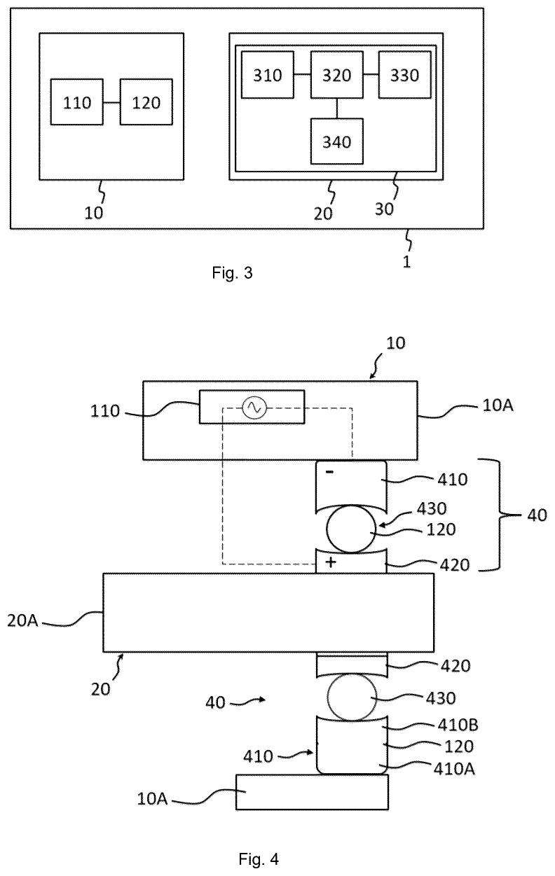

With reference to FIGS. 2 and 3, the sensor 30 comprises a “remote” piezoelectric transceiver 310, a measurement stage 320 and a sensitive element 330.

The remote piezoelectric transceiver 310 is configured to receive the ultrasonic supply signal SUA and to transmit it to the measurement stage 320.

The measurement stage 320 is configured to collect and store the electrical energy contained in the received ultrasonic supply signal SUA and to electrically power the sensitive element 330 on the basis of the stored electrical energy.

The sensitive element 330 is configured to measure a parameter inside the rotor 20, to generate a measurement signal S (FIG. 6) including at least one value of the measured parameter, and to transmit said generated measurement signal S to the measurement stage 320.

The measurement stage 320 is configured to extract the at least one value of the measured parameter contained in the measurement signal S, to generate an ultrasonic response signal SUR including the at least one extracted value of the parameter, and to command the remote piezoelectric transceiver 310 to transmit said generated ultrasonic response signal SUR to the main piezoelectric transceiver 120.

The main piezoelectric transceiver 120 is configured to receive said ultrasonic response signal SUR and to transmit said received ultrasonic response signal SUR to the control stage 110.

The control stage 110 is configured to extract the at least one value of the parameter contained in the transmitted ultrasonic response signal SUR and to control the position and/or the rotation speed of the rotor 20 on the basis of the at least one extracted value of the parameter.

In one embodiment, illustrated in FIG. 3, the sensor 30 comprises an external communication stage 340 and the measurement stage 320 is configured to command the transmission of signals containing the measured parameter values (extracted from the measurement signal S) via said external communication stage 340. This transmission may, for example, be carried out on a communication interface of Bluetooth type or of RFID type, which are known per se. In this case, the external communication stage 340 preferably comprises a microcontroller allowing this transmission function to be implemented.

In one embodiment:
the main piezoelectric transceiver 120 is configured to resonate at at least one predetermined frequency, preferably at two predetermined frequencies, for example 200 kHz and 2 MHz,
the control stage 320 is configured to generate a signal at said at least one predetermined frequency and to deliver the generated signal to the main piezoelectric transceiver 120, and
the remote piezoelectric transceiver 310 is configured to resonate at said at least one predetermined frequency in order to improve the quality of the ultrasonic signals transmitted between the main piezoelectric transceiver 120 and the remote piezoelectric transceiver 310.

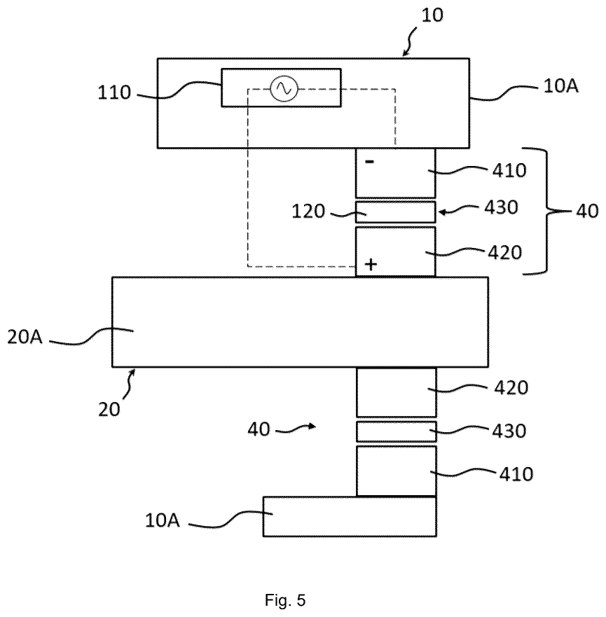

With reference now to FIGS. 1, 4 and 5, the stator 10 comprises an armature 10A and the rotor 20 comprises a rotation shaft 20A which allows the rotor 20 to be mounted on the stator 10 such that it is able to rotate via a plurality of rolling modules 40, only one of which is shown in FIGS. 4 and 5 for the sake of clarity, in a manner known per se.

It is necessary to have at least two rolling modules 40 that are circular, that is to say that completely surround the rotation shaft 20A of the rotor 20, or at least two sets of three rolling modules 40 of journal type, in order to support the rotor 20.

In the examples of FIGS. 4 and 5, the rolling module 40 is circular and comprises a fixed element 410, a movable element 420 and a plurality of rolling elements 430.

In this example, the fixed element 410 is in the form of a crown mounted on the armature 10A of the stator 10.

The movable element is likewise in the form of a crown mounted on the rotation shaft 20A of the rotor 20.

The rolling elements 430 are mounted between the fixed element 410 and the movable element 420, in a manner known per se, so as to allow the rotor 20 to rotate relative to the stator 10.

The rolling elements 430 of a rolling module 40 may be a set of balls or rollers, a crown, a ring or a torus.

The main piezoelectric transceiver 120 is one or more of the rolling elements 430.

To this end, the main piezoelectric transceiver 120 is made of ceramic.

The control stage is connected on the one hand to the fixed element 410 of the rolling module 40 and on the other hand to the movable element 420 of the rolling module 40 so as to constitute the excitation circuit of the main piezoelectric transceiver 120. The movable element 420 constitutes the fixed positive electrical terminal 410 for the main piezoelectric transceiver 120 while the fixed element 410 constitutes the negative electrical terminal for the main piezoelectric transceiver 120.

In the example of FIG. 4, the main piezoelectric transceiver 120 is a ball or all the balls of the rolling module 40.

In the example of FIG. 5, the main piezoelectric transceiver 120 is a crown which constitutes the rolling element 430 of the rolling module 40.

### EXAMPLE OF IMPLEMENTATION

One example of implementation of the electrical machine 1 will now be described with reference to FIG. 6. In this non-limiting example, the parameter to be measured may, for example, be the temperature inside a rotor 20A of the electrical machine 20.

First of all, when the parameter needs to be measured, the control stage 110 commands, in a step E1, the piezoelectric transmitter 120 to transmit ultrasonic signals. The main piezoelectric transceiver 120 transmits, in a step E2, an ultrasonic supply signal SUA to the remote piezoelectric transceiver 310 which receives it in a step E3.

In a step E4, the measurement stage 320 of the sensor 30 collects and stores the electrical energy contained in the received ultrasonic supply signal SUA, for example in a capacitor, and electrically powers the sensitive element 330 on the basis of the stored electrical energy in a step E5.

The sensitive element 330 measures the parameter, for example the temperature, in a step E6 then generates a measurement signal S including at least one value of the measured parameter in a step E7.

The sensitive element 330 subsequently transmits, in a step E8, the generated measurement signal S to the measurement stage 320 which receives it and extracts the at least one value of the measured parameter contained in the measurement signal S in a step E9.

The measurement stage 320 then generates, in a step E10, an ultrasonic response signal SUR including the at least one extracted value of the parameter then commands the remote piezoelectric transceiver 310 to transmit said generated ultrasonic response signal SUR in a step E11.

The remote piezoelectric transceiver 310 transmits, in a step E12, the generated ultrasonic response signal SUR, which is received by the main piezoelectric transceiver 120 in a step E13.

The main piezoelectric transceiver 120 then transmits, in a step E14, the received ultrasonic response signal SUR to the control stage which extracts the at least one value of the parameter contained in said transmitted ultrasonic response signal in a step E15 then optionally controls the position of the rotor 20 in dependence on said at least one value of the measured parameter, for example to slow down the rotor 20 and prevent it from being damaged when the temperature measured inside the rotor is too high.

The invention therefore allows a parameter to be measured using a remote module which is powered with electrical energy at a distance, thus avoiding the use of a battery which needs to be changed, this being particularly advantageous in the case of a rotor of an electrical machine, while allowing efficient transmission of the signals between the control stage 110 and the sensor 30.

1. An electrical machine for a motor vehicle, said electrical machine comprising a stator and a rotor mounted on said stator such that it is able to rotate by a rotation shaft and a plurality of rolling modules, each rolling module comprising a fixed element mounted on the stator, a movable element mounted on the rotor, at least one rolling element mounted between the fixed element and the movable element and configured to allow the rotor to rotate relative to the stator, the electrical machine further comprising:
at least one rolling element of at least one rolling module is a “main” piezoelectric transceiver configured to transmit an ultrasonic supply signal,
the stator comprises a control stage configured to command said main piezoelectric transceiver to transmit,
the electrical machine comprises a sensor, mounted inside the rotor, comprising a “remote” piezoelectric transceiver, a measurement stage and a sensitive element, said remote piezoelectric transceiver being configured to receive the ultrasonic supply signal and to transmit it to the measurement stage, the measurement stage being configured to collect and store the electrical energy contained in the received ultrasonic supply signal and to electrically power the sensitive element on the basis of the stored electrical energy, the sensitive element being configured to measure a parameter inside the rotor, to generate a measurement signal including at least one value of the measured parameter and to transmit said generated measurement signal to the measurement stage, the measurement stage being configured to extract the at least one value of the measured parameter contained in the measurement signal, to generate an ultrasonic response signal including the at least one extracted value of the parameter, and to command the remote piezoelectric transceiver to transmit said generated ultrasonic response signal, the main piezoelectric transceiver being configured to receive said ultrasonic response signal and to transmit said received ultrasonic response signal to the control stage, said control stage being configured to extract the at least one value of the parameter contained in the transmitted ultrasonic response signal.

2. The electrical machine as claimed in claim 1, wherein the main piezoelectric transceiver is made of ceramic.

3. The electrical machine as claimed in claim 1, wherein the main piezoelectric transceiver is a ball or a roller.

4. The electrical machine as claimed in claim 1, wherein the main piezoelectric transceiver is a crown, a ring or a torus.

5. The electrical machine as claimed in claim 1, wherein all the rolling elements of at least one rolling module are main piezoelectric transceivers.

6. The electrical machine as claimed in claim 1, wherein each rolling module is circular and entirely surrounds the rotation shaft of the rotor.

7. The electrical machine as claimed in claim 1, wherein the control stage is configured to control the position of the rotor in dependence on the at least one extracted value of the parameter.

8. A motor vehicle comprising an electrical machine as claimed in claim 1, said electrical machine being configured to drive the wheels of said vehicle in rotation.

9. A method for measuring a parameter in a rotor of an electrical machine of a motor vehicle, said method comprising:
commanding, by the control stage, the main piezoelectric transceiver to transmit,
transmission, by the main piezoelectric transceiver, of an ultrasonic supply signal,
reception, by the remote piezoelectric transceiver, of the transmitted ultrasonic supply signal,
collection and storage, by the measurement stage, of the electrical energy contained in the received ultrasonic supply signal,
electrical powering, by the measurement stage, of the sensitive element on the basis of the stored electrical energy,
measurement, by the sensitive element, of the parameter,
generation, by the sensitive element, of a measurement signal including at least one value of the measured parameter,
transmission, by the sensitive element, of the generated measurement signal to the measurement stage,
extraction, by the measurement stage, of the at least one value of the measured parameter contained in the transmitted measurement signal,
generation, by the measurement stage, of an ultrasonic response signal including the at least one extracted value of the parameter,
commanding, by the measurement stage, the remote piezoelectric transceiver to transmit said generated ultrasonic response signal,
transmission, by the remote piezoelectric transceiver, of said generated ultrasonic response signal,
reception, by the main piezoelectric transceiver, of the transmitted ultrasonic response signal,
transmission, by the main piezoelectric transceiver, of the received ultrasonic response signal to the control stage,
extraction, by the control stage, of the at least one value of the parameter contained in the transmitted ultrasonic response signal.
